(19) United States
(12) Patent Application Publication
(10) Pub. No.: US 2024/0100759 A1
(43) Pub. Date: Mar. 28, 2024

(54) MIXTURES CONTAINING OXAMIDE-FUNCTIONAL SILOXANES AND ORGANIC FIBERS

(71) Applicant: Wacker Chemie AG, Munich (DE)

(72) Inventors: Oliver Schäfer, Burghausen (DE); Oliver Fuhrmann, Altenmarkt (DE); Michael Joachimbauer, Gumpersdorf (DE)

(73) Assignee: Wacker Chemie AG, Munich (DE)

(21) Appl. No.: 18/039,980

(22) PCT Filed: Dec. 18, 2020
(86) PCT No.: PCT/EP2020/086990

§ 371 Date: Jun. 2, 2023

(51) Int. Cl. B29C 48/16; B29C 48/00

(52) U.S. Cl. CPC B29C 48/16; B29C 48/022; B29K 2283/00

(57) ABSTRACT

Mixtures along with processes for making and uses for the same. The mixtures include organosilicon compounds, organic fibers, and/or thermoplastic polymers. The mixtures may optionally include polyolefins substituted by carboxylic acid anhydride groups and/or additives.

The invention relates to fiber-filled mixtures comprising oxamide-functional siloxanes, process additives used therein, to the preparation and use thereof.

The use of wood as a sustainable, traditional material is associated with some disadvantages, for example that the resistance to UV light and moisture is limited and the material tends to splinter on the surface, especially after weathering. In recent years, so-called WPC (wood polymer composite) has been increasingly used as wood substitute products for various purposes. These WPCs are plastics reinforced with wood or natural fibers, which may also comprise additives to avoid the disadvantages of wood with respect to UV protection and moisture on the one hand and to ensure a wood-like appearance on the other. Such products are known, for example, as a façade element or as a terrace decking, in the form of a so-called barefoot floorboard. The wood fiber content is typically between 10 and 90%, preferably between 30 and 80%, the remaining proportion consists essentially of organic plastics, mostly polyvinyl chloride (PVC) or polymers from the group of polyolefins, such as high-density polyethylene (HDPE) or polypropylene (PP), which may additionally be mixed with additives commonly used in plastics processing. These additives can be dyes and pigments, UV stabilizers or even flame retardants, so that outdoor use can be guaranteed for many years and, optionally, the fire resistance is increased so that these profiles may also be used in the construction sector. Additives against infestation by bacteria, insects, fungi, especially mold, algae or termites etc. can also be added to the WPC in order to improve the resistance compared to naturally grown solid wood.

These WPCs can either be produced directly as a semi-finished product, such as a profile, or as plastic granules, which can be shaped in further processing steps, such as extrusion or injection molding.

The natural or wood fiber-plastic mixtures are produced on typical plastics processing machines, such as twin-screw extruders or planetary roller extruders, which are intended to ensure good mixing of the wood fibers with the plastic. Since the mechanical parameters, such as the rigidity and flexural strength of the compounds produced in this way, continue to improve with increasing fiber content and these compounds take on an increasingly wood-like appearance, it is the aim of WPC manufacturers to maximize the wood fiber content. The disadvantage of this, however, is that the higher the fiber content, the more internal friction is increased, making processing more difficult and increasing wear on the mixing units. To avoid the processing problems that increasingly occur at higher fiber contents, so-called polymer processing aids (PPA) such as metal stearates, oligomeric polyolefin waxes or carboxylic acid amide derivatives are used. Depending on the type, these act as internal and external lubricants, thereby facilitating the mixing and processing process and possibly also leading to more homogeneous, more even surfaces of the extruded semi-finished products.

However, a disadvantage of the PPAs currently in use is their known tendency to partially adsorb on existing filler surfaces and thus become inactivated. This occurs in particular on the fiber surfaces present due to the high wood fiber content, which means that very high concentrations of PPAs sometimes have to be added. Here, between 2 and up to 6% by weight of PPA are added, which in these high concentrations, however, again have a negative effect on the rigidity of the WPC blends. In addition, the weldability of the profiles extruded in this way decreases, which is particularly notably disadvantageous in the production of window frames from WPC. In addition, the PPAs used also react with further polymer additives, so-called couplers or adhesion promoters, which by reactive groups ensure better adhesion of the wood fibers to the matrix plastics used, and are thus intended to improve the mechanical properties of the WPCs. These side reactions of the PPAs also inevitably thus lead to an undesirable deterioration in the mechanical properties of the WPCs. Therefore, polymer additives were sought that are only used in relatively small amounts in order to minimize possible interactions with matrix or fiber materials or other additives as far as possible.

Studies by Hristov et al are known, in which special thermoplastic silicones are used as process additives in WPC (Advances in Polymer Technology, Vol. 26, No. 2, 100-108 (2007)). However, the disadvantage here is that the products used by Hristov were used in relatively large amounts and thus, in addition to the desired positive effect on the processing properties, led to a partial deterioration of the mechanical properties of the WPC compound.

The object now consisted of finding a process additive that enables the production of WPCs by mixing plastics with natural and wood fibers in such a way that, on the one hand, large amounts of fibers can be incorporated into the plastic, but, on the other hand, the mechanical properties of the WPC compound are not noticeably worsened or even improved by the process additive and no longer show the disadvantages of the prior art. This has been achieved by the present invention. It has surprisingly been found that by combining linear silicones having relatively low molecular weights and small proportions of specific aliphatic oxamido substituents, compounds were obtained which exhibit significant process improvements when mixed into thermoplastic/wood fiber mixtures.

The invention therefore relates to mixtures comprising (A) organosilicon compounds of the general formula

R_{3-a-b}(OR¹)ₐR²_{b}Si[OSiR₂]ₚ[OSiRR²]_{q}[OSiR²₂]ᵣOSiR_{3-a-b}(OR¹)ₐR²_{b} (I),
where
R may be identical or different and is a monovalent, optionally substituted, SiC-bonded hydrocarbon radical,
R¹ may be identical or different and is a hydrogen atom or a monovalent, optionally substituted hydrocarbon radical,
R² is a SiC-bonded unit of the general formula

R³—X—[CO—(CO)ₙ]—X—R⁴— (II)
where
X may be identical or different and is —O— or —NR^{x}—,
R³ may be identical or different and are monovalent, optionally substituted hydrocarbon radicals having at least 6 carbon atoms,
R⁴ are divalent, optionally substituted hydrocarbon radicals having 1 to 40 carbon atoms, wherein individual carbon atoms may be replaced by oxygen atoms or —NR^{z}—,
R^{x} may be identical or different and is a hydrogen atom or monovalent, optionally substituted hydrocarbon radicals having 1 to 20 carbon atoms, wherein individual carbon atoms may be replaced by oxygen atoms,
R^{z} may be identical or different and is a hydrogen atom or monovalent, optionally substituted hydrocarbon radicals having 1 to 20 carbon atoms, wherein individual carbon atoms may be replaced by oxygen atoms,
n is 0 or 1,
a is 0, 1, 2 or 3,
b is 0 or 1,
p is an integer from 1 to 1000,
q is 0 or an integer from 1 to 100 and
r is 0 or an integer from 1 to 100,
with the proviso that a+b is ≤3 and at least one R² radical is present,
(B) organic fibers,
(C) thermoplastic polymers and
optionally
(D) polyolefins substituted by carboxylic acid anhydride groups.

Examples of R are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl radical and methylcyclohexyl radicals; alkenyl radicals such as the vinyl, 1-propenyl and 2-propenyl radical; aryl radicals such as the phenyl, naphthyl, anthryl and phenanthryl radical; alkaryl radicals such as o-, m-, p-tolyl radicals; xylyl radicals and ethylphenyl radicals; or aralkyl radicals such as the benzyl radical or the α- and β-phenylethyl radicals.

Examples of halogenated radicals R are haloalkyl radicals such as the 3,3,3-trifluoro-n-propyl radical, the 2,2,2,2′,2′,2′-hexafluoroisopropyl radical and the heptafluoroisopropyl radical.

The radical R is preferably a monovalent hydrocarbon radical having 1 to 20 carbon atoms, optionally substituted by fluorine and/or chlorine atoms, more preferably a hydrocarbon radical having 1 to 6 carbon atoms, especially the methyl, ethyl, vinyl or phenyl radical.

Examples of radical R¹ are the radicals specified for the radical R and also polyalkylene glycol radicals attached via a carbon atom.

The radical R¹ is preferably hydrocarbon radicals, more preferably hydrocarbon radicals having 1 to 8 carbon atoms, especially the methyl or ethyl radical.

Examples of radical R³ are the examples specified for the radical R for optionally substituted hydrocarbon radicals having at least 6 carbon atoms, such as n-hexyl radicals or dodecyl radicals.

The radical R³ is preferably aliphatic hydrocarbon radicals having at least 6 carbon atoms, particularly preferably aliphatic hydrocarbon radicals having at least 10 carbon atoms.

Examples of radical R⁴ are alkylene radicals such as the methylene, ethylene, n-propylene, isopropylene, n-butylene, isobutylene, tert-butylene, n-pentylene, isopentylene, neopentylene, tert-pentylene radical, hexylene, heptylene, octylene, nonylene, decylene, dodecylene or octadecylene radicals; cycloalkylene radicals such as the cyclopentylene radical, 1,4-cyclohexylene radical, isophoronylene radical or 4,4′-methylenedicyclohexylene radical; alkenylene radicals such as the vinylene, n-hexenylene, cyclohexenylene, 1-propenylene, allylene, butenylene or 4-pentenylene radical; alkynylene radicals such as the ethynylene or propargylene radical; arylene radicals such as the phenylene, bisphenylene, naphthylene, anthrylene or phenanthrylene radical; alkarylene radicals such as the o-, m-, p-tolylene radicals, xylylene radicals or ethylphenylene radicals; or aralkylene radicals such as the benzylene radical, the 4,4′-methylenediphenylene radical, the α- or β-phenylethylene radical or the ethylene-propylene ether radical or the ethylene-propylene amine radical.

The radical R⁴ are preferably alkylene radicals, particularly preferably methylene or n-propylene radicals.

Examples of radical R^{x} and R^{z} are each independently the radicals specified for the radical R and the hydrogen atom.

The radical R^{x} is preferably a hydrogen atom or alkyl radicals, more preferably a hydrogen atom.

The radical R^{z} is preferably a hydrogen atom or alkyl radicals, more preferably a hydrogen atom.

X preferably has the definition —NR^{x}—, where R^{x} is as defined above.

Index n is preferably equal to 1.

Examples of radical R² are
H₁₃C₆—NH—CO—CO—NH—C₃H₆—, H₁₅C₇—NH—CO—CO—NH—C₃H₆—, H₁₇C₈—NH—CO—CO—NH—C₃H₆—, H₁₉C₉—NH—CO—CO—NH—C₃H₆—, H₂₁C₁₀—NH—CO—CO—NH—C₃H₆—, H₂₃C₁₁—NH—CO—CO—NH—C₃H₆—, H₂₅C₁₂—NH—CO—CO—NH—C₃H₆—, H₂₇C₁₃—NH—CO—CO—NH—C₃H₆—, H₂₉C₁₄—NH—CO—CO—NH—C₃H₆—, H₃₁C₁₅—NH—CO—CO—NH—C₃H₆—, H₃₃C₁₆—NH—CO—CO—NH—C₃H₆—, H₃₅C₁₇—NH—CO—CO—NH—C₃H₆—, H₃₇C₁₈—NH—CO—CO—NH—C₃H₆—, H₃₉C₁₉—NH—CO—CO—NH—C₃H₆—, H₄₁C₂₀—NH—CO—CO—NH—C₃H₆—, H₁₃C₆—NH—CO—NH—C₃H₆—, H₁₅C₇—NH—CO—NH—C₃H₆—, H₁₇C₈—NH—CO—NH—C₃H₆—, H₁₉C₉—NH—CO—NH—C₃H₆—, H₂₁C₁₀—NH—CO—NH—C₃H₆—, H₂₃C₁₁—NH—CO—NH—C₃H₆—, H₂₅C₁₂—NH—CO—NH—C₃H₆—, H₂₇C₁₃—NH—CO—NH—C₃H₆—, H₂₉C₁₄—NH—CO—NH—C₃H₆—, H₃₁C₁₅—NH—CO—NH—C₃H₆—, H₃₃C₁₆—NH—CO—NH—C₃H₆—, H₃₅C₁₇—NH—CO—NH—C₃H₆—, H₃₇C₁₈—NH—CO—NH—C₃H₆—, H₃₉C₁₉—NH—CO—NH—C₃H₆—, H₄₁C₂₀—NH—CO—NH—C₃H₆—,
H₁₁C₆—NH—CO—CO—NH—C₃H₆—, H₁₃C₇—NH—CO—CO—NH—C₃H₆—, H₁₅C₈—NH—CO—CO—NH—C₃H₆—, H₁₇C₉—NH—CO—CO—NH—C₃H₆—, H₁₉C₁₀—NH—CO—CO—NH—C₃H₆—, H₂₁C₁₁—NH—CO—CO—NH—C₃H₆—, H₂₃C₁₂—NH—CO—CO—NH—C₃H₆—, H₂₅C₁₃—NH—CO—CO—NH—C₃H₆—, H₂₇C₁₄—NH—CO—CO—NH—C₃H₆—, H₂₉C₁₅—NH—CO—CO—NH—C₃H₆—, H₃₁C₁₆—NH—CO—CO—NH—C₃H₆—, H₃₃C₁₇—NH—CO—CO—NH—C₃H₆—, H₃₅C₁₈—NH—CO—CO—NH—C₃H₆—, H₃₇C₁₉—NH—CO—CO—NH—C₃H₆—, H₃₉C₂₀—NH—CO—CO—NH—C₃H₆—, H₁₃C₆—NH—CO—CO—NH—C₂H₄—NH—C₃H₆—, H₁₅C₇—NH—C₂H₄—NH—CO—CO—NH—C₃H₆—, H₁₇C₈—NH—CO—CO—NH—C₂H₄—NH—C₃H₆—, H₁₉C₉—NH—CO—CO—NH—C₂H₄—NH—C₃H₆—, H₂₁C₁₀—NH—CO—CO—NH—C₂H₄—NH—C₃H₆—, H₂₃C₁₁—NH—CO—CO—NH—C₂H₄—NH—C₃H₆—, H₂₅C₁₂—NH—CO—CO—NH—C₂H₄—NH—C₃H₆—, H₂₇C₁₃—NH—CO—CO—NH—C₂H₄—NH—C₃H₆—, H₂₉C₁₄—NH—CO—CO—NH—C₂H₄—NH—C₃H₆—, H₃₁C₁₅—NH—CO—CO—NH—C₂H₄—NH—C₃H₆—, H₃₃C₁₆—NH—CO—CO—NH—C₂H₄—NH—C₃H₆—, H₃₅C₁₇—NH—CO—CO—NH—C₂H₄—NH—C₃H₆—, H₃₇C₁₈—NH—CO—CO—NH—C₂H₄—NH—C₃H₆—, H₃₉C₁₉—NH—CO—CO—NH—C₂H₄—NH—C₃H₆— and
H₄₁C₂₀—NH—CO—CO—NH—C₂H₄—NH—C₃H₆—, where preference is given to H₂₁C₁₀—NH—CO—CO—NH—C₃H₆—, H₂₃C₁₁—NH—CO—CO—NH—C₃H₆—, H₂₅C₁₂—NH—CO—CO—NH—C₃H₆—, H₂₇C₁₃—NH—CO—CO—NH—C₃H₆—, H₂₉C₁₄—NH—CO—CO—NH—C₃H₆—, H₃₁C₁₅—NH—CO—CO—NH—C₃H₆—, H₃₃C₁₆—NH—CO—CO—NH—C₃H₆—, H₃₅C₁₇—NH—CO—CO—NH—C₃H₆—, H₃₇C₁₈—NH—CO—CO—NH—C₃H₆—, H₂₁C₁₀—NH—CO—CO—NH—C₂H₄—NH—C₃H₆—, H₂₃C₁₁—NH—CO—CO—NH—C₂H₄—NH—C₃H₆—, H₂₅C₁₂—NH—CO—CO—NH—C₂H₄—NH—C₃H₆—, H₂₇C₁₃—NH—CO—CO—NH—C₂H₄—NH—C₃H₆—, H₂₉C₁₄—NH—CO—CO—NH—C₂H₄—NH—C₃H₆—, H₃₁C₁₅—NH—CO—CO—NH—C₂H₄—NH—C₃H₆—, H₃₃C₁₆—NH—CO—CO—NH—C₂H₄—NH—C₃H₆—, H₃₅C₁₇—NH—CO—CO—NH—C₂H₄—NH—C₃H₆—, H₃₇C₁₈—NH—CO—CO—NH—C₂H₄—NH—C₃H₆— or mixtures thereof and particular preference is given to H₂₅C₁₂—NH—CO—CO—NH—C₃H₆—, H₂₉C₁₄—NH—CO—CO—NH—C₃H₆—, H₃₃C₁₆—NH—CO—CO—NH—C₃H₆—, H₃₇C₁₈—NH—CO—CO—NH—C₃H₆—, H₂₅C₁₂—NH—CO—CO—NH—C₂H₄—NH—C₃H₆—, H₂₉C₁₄—NH—CO—CO—NH—C₂H₄—NH—C₃H₆— or H₃₃C₁₆—NH—CO—CO—NH—C₂H₄—NH—C₃H₆—.
a is preferably 0 or 1, more preferably 0.
b is preferably 0 or 1, more preferably 1.
p is preferably an integer from 10 to 500, more preferably an integer from 30 to 300.
q is preferably 0 or an integer from 1 to 20, more preferably 0 or an integer from 1 to 5.
r is preferably 0 or an integer from 1 to 10, more preferably 0 or an integer from 1 to 5, especially 0.

The organosilicon compounds of the formula (I) used in accordance with the invention preferably have a number-average molecular weight Mn of 1000 g/mol to 35 000 g/mol and more preferably a number-average molecular weight Mn of 3000 g/mol to 20 000 g/mol.

The number-average molar mass Mo is determined in the context of the present invention by size-exclusion chromatography (SEC) on a Styragel HR3-HR4-HR5-HR5 column set from Waters Corp. USA in THE with an injected volume of 100 μl against a polystyrene standard and at 60° C., a flow rate of 1.2 ml/min, and detection by RI (refractive index detector).

The organosilicon compounds (A) preferably have a melting point of below 200° C., particularly preferably of below 100° C., especially preferably of below 75° C., in each case at 1013 hPa.

The silicon content of the organosilicon compounds (A) is preferably 25% to 37.5% by weight, more preferably 30% to 37% by weight.

The organosilicon compounds of formula (I) used in accordance with the invention are preferably

R₂R²Si[OSiR₂]ₚ[OSiRR²]_{q}OSiR₂R² where
R=methyl, R²=H₂₅C₁₂—NH—[CO—CO]—NH—(CH₂)₃—, p=150, q=0,
R=methyl, R²=H₂₅C₁₂—NH—[CO—CO]—NH—(CH₂)₃—, p=80, q=0,
R=methyl, R²=H₂₅C₁₂—NH—[CO—CO]—NH—(CH₂)₃—, p=250, q=0,
R=methyl, R²=H₃₃C₁₆—NH—[CO—CO]—NH—(CH₂)₃—, p=150, q=0,
R=methyl, R²=H₃₃C₁₆—NH—[CO—CO]—NH—(CH₂)₃—, p=80, q=0,
R=methyl, R²=H₃₃C₁₆—NH—[CO—CO]—NH—(CH₂)₃—, p=250, q=0,
R=methyl, R²=H₃₇C₁₈—NH—[CO—CO]—NH—(CH₂)₃—, p=150, q=0,
R=methyl, R²=H₃₇C₁₈—NH—[CO—CO]—NH—(CH₂)₃—, p=80, q=0,
R=methyl, R²=H₃₇C₁₈—NH—[CO—CO]—NH—(CH₂)₃—, p=250, q=0,
R=methyl, R²=H₂₅C₁₂—NH—CO—NH—(CH₂)₃—, p=150, q=0,
R=methyl, R²=H₂₅C₁₂—NH—CO—NH—(CH₂)₃—, p=80, q=0,
R=methyl, R²=H₂₅C₁₂—NH—CO—NH—(CH₂)₃—, p=250, q=0,
R=methyl, R²=H₃₃C₁₆—NH—CO—NH—(CH₂)₃—, p=150, q=0,
R=methyl, R²=H₃₃C₁₆—NH—CO—NH—(CH₂)₃—, p=80, q=0,
R=methyl, R²=H₃₃C₁₆—NH—CO—NH—(CH₂)₃—, p=250, q=0,
R=methyl, R²=H₂₅C₁₂—NH—[CO—CO]—NH—(CH₂)₃—, p=150, q=2,
R=methyl, R²=H₂₅C₁₂—NH—[CO—CO]—NH—(CH₂)₃—, p=80, q=1,
R=methyl, R²=H₂₅C₁₂—NH—[CO—CO]—NH—(CH₂)₃—, p=250, q=3,
R=methyl, R²=H₂₅C₁₂—NH—[CO—CO]—NH—(CH₂)₂—NH—(CH₂)₃—, p=150, q=0,
R=methyl, R²=H₂₅C₁₂—NH—[CO—CO]—NH—(CH₂)₂—NH—(CH₂)₃—, p=80, q=0,
R=methyl, R²=H₂₅C₁₂—NH—[CO—CO]—NH—(CH₂)₂—NH—(CH₂)₃—, p=250, q=0,
R=methyl, R²=H₂₅C₁₂—NH—[CO—CO]—NH—(CH₂)₂—NH—(CH₂)₃—, p=250, q=3,
or organosilicon compounds of the formula (I)

R₃Si[OSiR₂]ₚ[OSiRR²]OSiR₃ where
R=methyl, R²=H₂₅C₁₂—NH—[CO—CO]—NH—(CH₂)₃—, p=150, q=2,
R=methyl, R²=H₂₅C₁₂—NH—[CO—CO]—NH—(CH₂)₃—, p=80, q=1,
R=methyl, R²=H₂₅C₁₂—NH—[CO—CO]—NH—(CH₂)₃—, p=250, q=4,
R=methyl, R²=H₂₅C₁₂—NH—CO—NH—(CH₂)₃—, p=150, q=2,
R=methyl, R²=H₂₅C₁₂—NH—CO—NH—(CH₂)₃—, p=80, q=1,
R=methyl, R²=H₂₅C₁₂—NH—CO—NH—(CH₂)₃—, p=250, q=4,
R=methyl, R²=H₂₅C₁₂—NH—[CO—CO]—NH—(CH₂)₂—NH—(CH₂)₃—, p=150, q=2,
R=methyl, R²=H₂₅C₁₂—NH—[CO—CO]—NH—(CH₂)₂—NH—(CH₂)₃—, p=80, q=1,
R=methyl, R²=H₂₅C₁₂—NH—[CO—CO]—NH—(CH₂)₂—NH—(CH₂)₃—, p=250, q=4,
R=methyl, R²=H₃₃C₁₆—NH—[CO—CO]—NH—(CH₂)₃—, p=150, q=2,
R=methyl, R²=H₃₃C₁₆—NH—[CO—CO]—NH—(CH₂)₃—, p=80, q=1,
R=methyl, R²=H₃₃C₁₆—NH—[CO—CO]—NH—(CH₂)₃—, p=250, q=3,
R=methyl, R²=H₃₇C₁₈—NH—[CO—CO]—NH—(CH₂)₃—, p=150, q=2,
R=methyl, R²=H₃₇C₁₈—NH—[CO—CO]—NH—(CH₂)₃—, p=80, q=1,
R=methyl, R²=H₃₇C₁₈—NH—[CO—CO]—NH—(CH₂)₃—, p=250, q=3,
R=methyl, R²=H₃₃C₁₆—NH—[CO—CO]—NH—(CH₂)₂—NH—(CH₂)₃—, p=150, q=2,
R=methyl, R²=H₃₃C₁₆—NH—[CO—CO]—NH—(CH₂)₂—NH—(CH₂)₃—, p=80, q=1,
R=methyl, R²=H₃₃C₁₆—NH—[CO—CO]—NH—(CH₂)₂—NH—(CH₂)₃—, p=250, q=4,
particularly preferably are R₂R²Si[OSiR₂]ₚ[OSiRR₂]_{q}OSiR₂R² where
R=methyl, R²=H₂₅C₁₂—NH—[CO—CO]—NH—(CH₂)₃—, p=150, q=0,
R=methyl, R²=H₃₃C₁₆—NH—[CO—CO]—NH—(CH₂)₃—, p=150, q=0,
R=methyl, R²=H₃₇C₁₈—NH—[CO—CO]—NH—(CH₂)₃—, p=150, q=0,
R=methyl, R²=H₂₅C₁₂—NH—[CO—CO]—NH—(CH₂)₃—, p=150, q=2,
R=methyl, R²=H₂₅C₁₂—NH—[CO—CO]—NH—(CH₂)₂—NH—(CH₂)₃—, p=150, q=0,
or organosilicon compounds of the formula (I)

R₃Si[OSiR₂]ₚ[OSiRR²]_{q}OSiR₃ where
R=methyl, R²=H₂₅C₁₂—NH—[CO—CO]—NH—(CH₂)₃—, p=150, q=2,
R=methyl, R²=H₂₅C₁₂—NH—[CO—CO]—NH—(CH₂)₃—, p=250, q=3,
R=methyl, R²=H₃₃C₁₆—NH—[CO—CO]—NH—(CH₂)₃—, p=150, q=2,
R=methyl, R²=H₃₃C₁₆—NH—[CO—CO]—NH—(CH₂)₃—, p=250, q=4,
R=methyl, R²=H₃₇C₁₈—NH—[CO—CO]—NH—(CH₂)₃—, p=150, q=2,
R=methyl, R²=H₃₇C₁₈—NH—[CO—CO]—NH—(CH₂)₃—, p=250, q=4,
R=methyl, R²=H₃₃C₁₆—NH—[CO—CO]—NH—(CH₂)₂—NH—(CH₂)₃—, p=150, q=2.

The proportion of the organosilicon compounds (A) in the mixture according to the invention is preferably between 100 ppm by weight and 20 000 ppm by weight, preferably between 250 ppm by weight and 10 000 ppm by weight, especially preferably between 500 ppm by weight and 7000 ppm by weight.

Examples of thermoplastic polymers (C) used according to the invention are thermoplastic polyolefins such as polyethylene or polypropylene, and also polyamide, polyethylene terephthalate, polybutylene terephthalate, thermoplastic elastomers based on crosslinked rubber, ethylene-vinyl acetate, ethylene-butyl acrylate, polyhydroxybutyrate and/or copolymers or mixtures thereof, and polystyrene, impact-modified polystyrene, styrene-acrylonitrile copolymers, acrylonitrile-butadiene-styrene copolymers, polyvinyl chloride, polyvinylidene fluoride, ethylene tetrafluoroethylene (ETFE), polymethyl methacrylate and copolymers or mixtures thereof.

Polyolefins (C) used according to the invention particularly preferably comprise units of the general formula

[—CR⁶R⁷—CR⁸R⁹—]ₓ (III)
where R⁶, R⁷, R⁸ and R⁹ are each independently a hydrogen atom, saturated hydrocarbon radicals, unsaturated hydrocarbon radicals, aromatic hydrocarbon radicals, vinyl ester radicals, (meth)acrylic acid radicals or a halogen atom and x is a number between 100 and 100 000.

Preferably, radicals R⁶, R⁷, R⁸ and R⁹ are each independently a hydrogen atom, saturated hydrocarbon radicals such as a methyl, butyl or hexyl radical, aromatic hydrocarbon radicals such as the phenyl radical, or halogen atoms such as chlorine or fluorine, particular preference being given to a hydrogen atom, methyl radical or chlorine atom.

Preferred monomers for the production of component (C) are ethylene, propylene, vinyl chloride, vinyl acetate, styrene, 1-butene, 1-hexene, 1-octene or butadiene or mixtures thereof, more preferably ethylene, propylene or vinyl chloride.

Preferred examples of component (C) used according to the invention are low and high density polyethylenes (LDPE, LLDPE, HDPE), homo- and copolymers of propylene with, for example, ethylene, butene, hexene and octene (PP), homo- and copolymers of ethylene with vinyl acetate (EVA) or butyl acrylate (EBA), polyvinyl chloride (PVC) or polyvinyl chloride-ethylene copolymers or polystyrenes (PS, HIPS, EPS), with particular preference being given to polyethylene, polypropylene, polyvinyl chloride, ethylene-vinyl acetate copolymers (EVA) or mixtures thereof.

The polymers (C) are especially preferably high-density polyethylene (HDPE), polypropylene, ethylene-vinyl acetate copolymers (EVA) or mixtures thereof.

In the case of the thermoplastic polymers (C) or mixtures thereof used according to the invention, the temperature at which the loss factor (G″/G′) according to DIN EN ISO 6721-2:2008 has the value of 1, is preferably at least 40° C., particularly preferably at least 100° C.

The polymeric structure of the thermoplastic polymers (C) can be linear but also branched.

The nature of the organic polymers (C) used essentially determines the processing temperature of the mixture according to the invention.

The proportion of the thermoplastic polymers (C) in the mixtures according to the invention is preferably 10% by weight to 70% by weight, particularly preferably 15% by weight to 50% by weight, especially preferably 25% by weight to 45% by weight.

The component (C) used in accordance with the invention is a commercially available product or it can be produced by standard chemical processes.

The organic fibers (B) used according to the invention are preferably cellulose-containing organic fibers, particular preference being given to organic fibers having a cellulose content of from 30 to 55% by weight. The cellulose-containing organic fibers (B) are preferably cellulose-containing natural fibers, preferably of plant origin, in particular wood.

Wood which can be used as component (B) consists preferably of 30 to 55% by weight cellulose, 15 to 35% by weight polyose and 15 to 35% by weight lignin.

The organic fibers (B) used according to the invention can assume any geometry, but preference is given to fibers of which the length/diameter ratio is greater than 2 and especially preferably greater than 4.

Examples of organic fibers (B) used according to the invention are fibers from deciduous or coniferous trees such as maple, oak, cedar, pine and spruce, fibers from grasses or the husks of fruiting bodies or from other fibrous plants such as flax, cane sugar, peanut plants, coconuts, sisal, bamboo, hemp and rice husks or fibers from processing residues of plant fibers such as bagasse. Mixtures of the fiber types mentioned may also be used. The wood and natural fibers can also occur as waste from industrial processes, such as the furniture, parquet or paper industry.

Wood waste such as bark, sawdust or sawn timber can also be used as component (B) according to the invention, which is selected only with regard to color and particle size in order to influence the desired properties of the moldings to be produced therefrom.

If wood is used as component (B), it is preferably wood fibers or wood flour, particularly preferably compacted wood flour, especially those having a particle size of 150 μm to 500 μm.

Longer wood fibers affect the rigidity of the moldings, but reduce the impact resistance thereof. The smaller particles have a certain influence on the rigidity, but reduce the breaking strength of the moldings. On the grounds of avoiding wood flour dust, compacted wood flour is preferably used as component (B) according to the invention.

If wood is used as component (B), the water content thereof is preferably 6 to 8% by weight, but can be reduced to a preferred range of 0.5 to 2.0% by weight by drying.

Optionally, the wood to be used can be comminuted to powder by grinding in ball mills or similar.

The proportion of organic fibers (B) in the mixtures according to the invention is preferably between 30 and 90% by weight, particularly preferably between 45 and 85% by weight, especially between 50 and 70% by weight.

The component (D) optionally used is preferably polyolefins, particularly preferably polyethylene or polypropylene, the polymer backbone of which is partially substituted with carboxylic acid anhydride groups, particularly preferably polyolefins partially bearing maleic anhydride or malonic anhydride or succinic anhydride groups. In the natural fiber compound according to the invention, this component preferably fulfills the object of improving the binding of the natural fibers to the polymer matrix and thus improving the mechanical properties such as rigidity and strength.

Examples of optionally used component (D) are commercially available products from the Lotader® and the Orevac® product line from ARKEMA SA (F-Colombes), products from the ADMER® family from Mitsui & Co Deutschland GmbH (D-Dusseldorf) or products from SCONA® product range from BYK Kometra GmbH (D-Schkopau).

If polyolefins (D) substituted by carboxylic acid anhydride groups are used, then these are used in amounts of preferably 0.1% by weight to 5% by weight, preferably in amounts of 0.5% by weight to 3% by weight and particularly preferably in amounts of 1% by weight to 2.5% by weight, based in each case on the total weight of the mixture according to the invention. The mixtures according to the invention preferably comprise component (D).

In addition to components (A), (B) (C) and optionally (D), the mixtures according to the invention may comprise further substances, such as flame retardants (E), biocides (F), pigments (G), UV absorbers (H), HALS stabilizers (I), inorganic fibers (J), lubricants (K) and adhesion promoters (L).

Examples of flame retardants (E) optionally used in accordance with the invention are organic flame retardants based on halogenated organic compounds or inorganic flame retardants, for example aluminum hydroxide (ATH) or magnesium hydroxide.

When flame retardants (E) are used, preference is given to inorganic flame retardants such as ATH.

Examples of biocides (F) optionally used in accordance with the invention are inorganic fungicides, inter alia borates, for example zinc borate, or organic fungicides, for example thiabendazole.

Examples of pigments (G) optionally used in accordance with the invention are organic pigments or inorganic pigments, for example iron oxides or titanium dioxide.

When pigments (G) are used, this is in amounts of preferably from 0.2% to 7% by weight, more preferably from 0.5% to 3% by weight. Pigments (G) are preferably used, especially in the form of a premix with component (C).

Examples of UV absorbers (H) optionally used in accordance with the invention are benzophenones, benzotriazoles or triazines.

If UV absorbers (H) are used, preference is given to benzotriazoles and triazines.

Examples of HALS stabilizers (I) optionally used in accordance with the invention are for example piperidine or piperidyl derivatives and are available inter alia under the Tinuvin® brand name (BASF, D-Ludwigshafen).

Examples of the inorganic fibers (J) optionally used according to the invention are glass fibers, basalt fibers or wollastonites, preference being given to glass fibers.

If inorganic fibers (J) are used, the amounts involved are preferably from 1 to 30% by weight, more preferably 5 to 15% by weight. The mixtures according to the invention preferably do not comprise component (J).

Examples of component (K) optionally used according to the invention are so-called external lubricants such as molybdenum disulfide, silicone oils, fatty alcohols, fatty alcohol dicarboxylic acid esters, fatty acid esters, fatty acids, fatty acid monoamides, fatty acid diamides (amide wax), metal soaps, oligomeric fatty acid esters (fatty acid complex esters), fatty alcohol fatty acid esters, wax acids, wax acid esters, for example montanic acid esters and partially saponified montanic acid esters, paraffins or derivatives thereof.

The component (K) optionally used according to the invention is preferably fatty alcohols, fatty alcohol dicarboxylic acid esters, fatty acid esters, fatty acids, fatty acid monoamides, fatty acid diamides (amide wax), metal soaps, oligomeric fatty acid esters (fatty acid complex esters), fatty alcohol fatty acid esters, wax acids or wax acid esters, where fatty acid esters or fatty acid diamides are particularly preferred.

If component (K) is used, the amounts involved are preferably from 0.1 to 5% by weight, particularly preferably 0.15 to 2% by weight. The mixtures according to the invention preferably comprise component (K).

Examples of adhesion promoters (L) optionally used are polybutyl acrylates, polybutyl acrylate-ethylene copolymers, polyvinyl acetates, polyvinyl alcohols, polyvinyl acetate-ethylene copolymers, polyvinyl alcohol-ethylene copolymers, partially saponified polyvinyl acetates, partially saponified polyvinyl acetate-ethylene copolymers and polyethylenes functionalized with alkoxysilyl groups and polypropylenes functionalized with alkoxysilyl groups, with preference being given to polyvinyl acetates, polyvinyl acetate-ethylene copolymers and partially saponified polyvinyl acetate-ethylene copolymers and particular preference being given to polyvinyl acetate-ethylene copolymers.

If component (L) is used, the amounts involved are preferably from 0.2 to 10% by weight, particularly preferably 0.5 to 5% by weight. The mixtures according to the invention preferably comprise component (L).

The mixtures according to the invention are preferably those comprising
(A) organosilicon compounds of the formula (I),
(B) organic fibers,
(C) thermoplastic polymers,
optionally (D) polyolefins substituted by carboxylic acid anhydride groups,
optionally (E) flame retardants,
optionally (F) biocides,
optionally (G) pigments,
optionally (H) UV absorbers,
optionally (I) HALS stabilizers,
optionally (J) inorganic fibers,
optionally (K) lubricants and
optionally adhesion promoters (L).

Particularly preferably, the mixtures according to the invention are those comprising
(A) organosilicon compounds of the formula (I),
(B) wood fibers,
(C) HDPE,
(D) polyethylene substituted by carboxylic acid anhydride groups,
(G) pigments,
(K) lubricants and
(L) adhesion promoters.

In a further particularly preferred embodiment, the mixtures according to the invention are those comprising
(A) organosilicon compounds of the formula (I),
(B) wood fibers,
(C) polypropylene,
(D) polypropylene substituted by carboxylic acid anhydride groups,
(G) pigments,
(K) lubricants and
(L) adhesion promoters.

In a further particularly preferred embodiment, the mixtures according to the invention are those comprising
(A) organosilicon compounds of the general formula (I),
(B) organic fibers,
(C) polypropylene,
(D) polypropylene substituted by carboxylic acid anhydride groups,
(G) pigments,
(H) UV absorbers,
(K) lubricants and
(L) adhesion promoters.

In a further particularly preferred embodiment, the mixtures according to the invention are those comprising
(A) organosilicon compounds of the general formula (I),
(B) organic fibers,
(C) HDPE,
(D) polyethylene substituted by carboxylic acid anhydride groups,
(G) pigments,
(H) UV absorbers,
(K) lubricants and
(L) adhesion promoters.

In a further particularly preferred embodiment, the mixtures according to the invention are those comprising
(A) organosilicon compounds of the general formula (I),
(B) organic fibers,
(C) PVC and
(K) lubricants.

The mixtures according to the invention preferably comprise no further constituents other than components (A) to (L).

The individual constituents of the mixtures according to the invention may in each case be one kind of such a constituent or else a mixture of at least two different kinds of such constituents.

The mixtures according to the invention may be produced by any existing known process, such as mixing the components in any desired sequence. Mixers or kneaders or extruders of the prior art may be used for this purpose.

The present invention further relates to a process for producing the mixtures according to the invention by mixing the individual components in any desired sequence.

In a preferred embodiment of the process according to the invention, component (A) is mixed together with component (B) and component (C) and optionally with one or more of components (D) to (L). The mixing is carried out preferably at temperatures between 100° C. and 230° C., particularly preferably at temperatures between 160° C. and 200° C. The mixing may be carried out continuously, discontinuously or semi-continuously. All mixers, kneaders or extruders known hitherto may be used for the mixing process, with the components used being added to the mixer either individually or as a physical mixture of two or more components.

Since the organosilicon compound (A) is used preferably only in very small amounts, it is desirable to meter in component (A) precisely in the required amounts in an industrial process and also to distribute it as homogeneously as possible in the mixture according to the invention during processing in order to ensure uniform effectiveness during processing. Surprisingly, this was achieved by using the organosilicon compound (A) in a suitable premix.

The invention further relates to compositions (Z) comprising
(A) at least one organosilicon compound of the general formula (I),
(C1) thermoplastic polymers selected from the group consisting of ethylene-vinyl acetate copolymers and ethylene-alkyl acrylate copolymers, and optionally (Y) additives.

The proportion of the thermoplastic polymers (C1) in the compositions (Z) according to the invention is preferably 30 to 99.99% by weight, particularly preferably 50 to 90% by weight, especially preferably 55 to 85% by weight.

Thermoplastic polymers (C1) used according to the invention preferably comprise units of the general formula

[—CH₂—CHR¹⁰—]ₓ (IV),
where R¹⁰ is in each case independently a hydrogen atom, vinyl ester radicals or alkyl acrylate radicals and x is a number between 100 and 100 000.

The radicals R¹⁰ are preferably each independently a hydrogen atom, alkyl acrylate radicals such as ethyl acrylate or butyl acrylate radical or vinyl ester radicals such as vinyl acetate radical, where particular preference is given to hydrogen atom, butyl acrylate radical or vinyl acetate radical.

Examples of polymers (C1) used according to the invention are ethylene-vinyl acetate copolymers (EVA), ethylene-methyl acrylate copolymer (EMA) or ethylene-butyl acrylate copolymers (EBA) and mixtures thereof, where preference is given to ethylene-vinyl acetate copolymers (EVA) or ethylene-butyl acrylate copolymers (EBA) and very particular preference is given to ethylene-vinyl acetate copolymers (EVA).

Preferred monomers for producing component (C1) are ethylene, vinyl acetate, methyl acrylate, butyl acrylate or mixtures thereof, particular preference being given to ethylene or vinyl acetate.

The proportion of ethylene in the polymers (C1) used is preferably from 50% by weight to 95% by weight, particularly preferably from at least 60% by weight to 90% by weight, especially preferably from 70% by weight to 85% by weight.

In the case of the thermoplastic polymers (C1) used according to the invention, the temperature at which the loss factor (G″/G′) according to DIN EN ISO 6721-2:2008 has the value of 1, is preferably between 40° C. and 200° C., particularly preferably between 40° C. and 150° C., especially preferably between 40° C. and 100° C.

The polymeric structure of the thermoplastic polymers (C1) can be linear but also branched.

The nature of the organic polymers (C1) used essentially determines the processing temperature of the mixture according to the invention.

The component (C1) used in accordance with the invention is a commercially available product or it can be produced by standard chemical processes.

The additives (Y) also optionally used in the composition (Z) can be selected from the group of components (D) to (L) described above. However, additives from the group of lubricants (K) are preferably used here.

Examples of component (Y) optionally used according to the invention are therefore especially lubricants such as molybdenum disulfide, silicone oils, fatty alcohols, fatty alcohol dicarboxylic acid esters, fatty acid esters, fatty acids, fatty acid monoamides, fatty acid diamides (amide wax), metal soaps, oligomeric fatty acid esters (fatty acid complex esters), fatty alcohol fatty acid esters, wax acids, wax acid esters, for example montanic acid esters and partially saponified montanic acid esters, paraffins or derivatives thereof.

Component (Y) optionally used according to the invention is preferably saturated fatty acid esters, unsaturated fatty acid esters, ethoxylated saturated fatty acid esters or ethoxylated unsaturated fatty acid esters, where particular preference is given to saturated fatty acid esters or ethoxylated saturated fatty acid esters.

If component (Y) is used, the amounts involved are preferably from 2 to 25% by weight, particularly preferably 10 to 20% by weight. The compositions (Z) according to the invention preferably comprise component (Y).

The present invention further relates to a process for producing the compositions (Z) according to the invention by mixing the individual components in any desired sequence.

In a preferred embodiment for producing the composition (Z) according to the invention, component (A) is mixed together with component (C1) and optionally with one or more components (Y). The mixing is carried out preferably at temperatures between 70° C. and 180° C., particularly preferably at temperatures between 90° C. and 150° C. The mixing may be carried out continuously, discontinuously or semi-continuously. All mixers, kneaders or extruders known hitherto may be used for the mixing process, wherein the components used may be added to the mixer either individually or as a physical mixture of two or more components.

Components (A) and (C1) and optionally component (Y) are preferably mixed continuously in an extruder or kneader of the prior art. The copolymer (A) is present in this premix in an amount preferably between 2 and 35% by weight, more preferably between 10 and 30% by weight, especially preferably between 12 and 25% by weight, based in each case on the weight of the premix.

The premix (Z) produced according to the invention is preferably present in the form of pellets or powder, but preferably in the form of pellets. The pellets may also be processed into a powder by mechanical grinding or obtained as micropellets via an appropriate pelletization unit.

In a particularly preferred embodiment of the process according to the invention, composition (Z) according to the invention is mixed with component (B), component (C) and optionally one or more of components (D) to (L). The mixing can be carried out continuously, discontinuously or semi-continuously. All mixers, kneaders or extruders known hitherto can be used for the mixing process. The mixing is likewise carried out preferably at temperatures between 100° C. and 230° C., particularly preferably at temperatures between 160° C. and 200° C. The mixing may be carried out continuously, discontinuously or semi-continuously. All mixers, kneaders or extruders known hitherto may be used for the mixing process, with the components used being added to the mixer either individually or as a physical mixture of two or more components.

The process according to the invention may be carried out in the presence or absence of a solvent, preference being given to solvent-free production.

The process according to the invention may be carried out continuously, discontinuously or semi-continuously, but preferably continuously.

The process according to the invention is preferably carried out in continuously operated kneaders or mixers or extruders, wherein the individual components to be mixed according to the invention are each continuously supplied to the mixing unit gravimetrically or volumetrically, either in pure form or as a premix. Components present in the overall mixture at a proportion of less than 1% by weight are preferably supplied as a premix in one of the components present in a larger proportion.

The temperatures at which the process according to the invention is carried out depend primarily on the components used and are known to those skilled in the art, with the proviso that they are below the specific decomposition temperatures of the individual components used. The process according to the invention is preferably carried out at temperatures below 250° C., more preferably in a range from 150 to 220° C.

The process according to the invention is preferably carried out at the pressure of the surrounding atmosphere, that is to say between 900 and 1100 hPa. However, higher pressures may also be employed, depending in particular on the mixing unit used. For instance, the pressure in different areas of the kneaders, mixers or extruders used is for example significantly greater than 1000 hPa.

After the mixing process of the individual components, the mixture according to the invention is then preferably discharged from the reactor as a hot, highly viscous melt via a nozzle. In a preferred process, the material is cooled after discharge by means of a cooling medium and then comminuted or granulated. Here, the cooling of the material and the pelletization can be accomplished simultaneously by underwater pelletization, or one after the other. Either water or air are used as preferred cooling media. Preferred methods of pelletization are underwater pelletization, pelletization by air cutting or strand pelletization. The pellets obtained have a weight of preferably less than 0.5 g, more preferably less than 0.25 g, especially less than 0.125 g. Preferably, the pellets obtained according to the invention are cylindrical or spherical.

The pellets thus obtained may be extruded in a subsequent step by means of further thermoplastic processing to form a molding, preferably a profile. According to a preferred procedure, the compositions according to the invention are continuously conveyed in pellet form into a kneader or extruder of the prior art, heated and plasticized in this kneader or extruder through the influence of temperature, and then pressed through a nozzle that dictates the desired profile shape. Depending on the design of the nozzle, either solid profiles or hollow profiles can be produced here.

The invention further relates to moldings produced by extrusion of the mixtures according to the invention.

In a preferred embodiment, the mixture according to the invention is extruded directly, via an appropriate nozzle, continuously in the form of a profile, which can then—likewise after cooling—be trimmed and/or cut to length.

The mixture according to the invention may be produced using mixers or kneaders or extruders of the prior art.

The mixtures obtained are preferably thermoplastic, meaning that the temperature at which the loss factor (G″/G′) in accordance with DIN EN ISO 6721-2:2008 takes the value of 1 is preferably at least 40° C., particularly preferably at least 100° C.

The mixtures obtained preferably have a modulus of elasticity (according to ISO 527) of greater than 1000 MPa, particularly preferably greater than 2000 MPa.

The mixtures according to the invention exhibit excellent properties in terms of rigidity and low water absorption, as a result of which the mixtures may be used especially in outdoor applications.

The mixtures according to the invention can be used anywhere where so-called WPCs have also been employed to date.

Preferred applications of the polymer mixtures according to the invention are uses as a constituent for profiles in the construction sector or as a compound for automotive interior applications.

The mixtures according to the invention have the advantage that they are easy to produce.

The mixtures according to the invention also have the advantage that their water absorption is low.

The mixtures according to the invention have the advantage that the addition of the siloxane-containing component (A) improves mechanical properties, such as the impact resistance, strength and rigidity of the finished mixture.

The mixtures according to the invention have the advantage that the addition of the siloxane-containing component (A) improves the abrasion resistance and scratch resistance of the finished mixtures.

The compositions (Z) according to the invention have the advantage that the surfaces of the profiles obtained are significantly smoother in the direct extrusion of 3-dimensional profiles.

The process according to the invention has the advantage that the mechanical abrasion of the metallic mixing or extruder elements is greatly reduced even with higher contents of organic fibers.

In the examples described below, all viscosity data are based on a temperature of 25° C. Unless stated otherwise, the examples that follow are conducted at a pressure of the surrounding atmosphere, that is to say at around 1000 hPa, and at room temperature, that is to say at around 23° C., or at a temperature as results when combining the reactants at room temperature without supplemental heating or cooling, and at a relative humidity of about 50%. In addition, unless otherwise stated, all reported parts and percentages relate to weight.

The following products are used in the examples:

Reactants:
Polymer PE 1: High-density polyethylene, MFI 4 g/10 min, commercially available under the name “BorPure MB7541” from Borealis Polyolefine, A-Linz;
Polymer PE 2: High-density polyethylene, MFI 0.3 g/10 min, commercially available under the name “BB2581” from Borealis Polyolefine, A-Linz;
Polymer PP 1: Polypropylene homopolymer, commercially available under the name “HC205 TF” from Borealis Polyolefine, A-Linz;
EVA1: Ethylene-vinyl acetate copolymer having a vinyl acetate content of 19% by weight, commercially available under the name “Escorene UL15019CC” from ExxonMobil Chemical Europe, Hermeslaan 2, 1831 Machelen, Belgium;
EVA2: Ethylene-vinyl acetate copolymer having a vinyl acetate content of 28% by weight, commercially available under the name “Escorene UL15028CC” from ExxonMobil Chemical Europe, Hermeslaan 2, 1831 Machelen, Belgium;
Amine 1: Dodecylamine, available under the name “Armeen 12D” from Nouryon, Stenungsund, Sweden;
Amine 2: 1-aminooctadecane, commercially available under the name Octadecylamine from Sigma-Aldrich;
Silicone 1: Ethyloxalamidopropyl-terminated polydimethylsiloxane of the formula H₅C₂₀—CO—CO—NH—C₃H₆—Si(CH₃)₂—[OSi(CH₃)₂]ₙ—OSi(CH₃)₂—C₃H₆—NH—CO—CO—OC₂H₅ having a number-average molecular weight Mn of 11 457 g/mol;
Silicone 2:
1.146 kg (0.1 mol) of silicone 1 were initially charged in a 2 l, 3-necked flask under a nitrogen atmosphere and heated to 80° C. with stirring. 37.1 g of amine 1 (0.2 mol) were then added and, after stirring for 30 minutes, the ethanol formed was distilled off by applying a pressure of 200 mbar. After stirring for a further 30 minutes, the product obtained was isolated as a polymer melt.

This gave 1173 g of a dodecylaminoxamidopropyl-terminated polydimethylsiloxane of the formula H₂₅C₁₂NH—CO—CO—NH—C₃H₆—Si(CH₃)₂—[OSi(CH₃)₂]ₙ—OSi(CH₃)₂—C₃H₆—NH—CO—CO—NHC₁₂H₂₅ having a number-average molecular weight of 11 733 g/mol and a melting point of 28° C.;
Silicone 3:
1.146 kg (0.1 mol) of silicone 1 were initially charged in a 2 l, 3-necked flask under a nitrogen atmosphere and heated to 80° C. with stirring. 53.9 g of amine 2 (0.2 mol) were then added and, after stirring for 30 minutes, the ethanol formed was distilled off by applying a pressure of 200 mbar. After stirring for a further 30 minutes, the product obtained was isolated as a polymer melt.

This gave 1184 g of an octadecylaminoxamidopropyl-terminated polydimethylsiloxane of the formula H₃₇C₁₈NH—CO—CO—NH—C₃H₆—Si(CH₃)₂—[OSi(CH₃)₂]ₙ—OSi(CH₃)₂—C₃H₆—NH—CO—CO—NHC₁₈H₃₇ having a number-average molecular weight of 11 833 g/mol and a melting point of 46° C.;
Additive Y1: Castor oil, available under the name “Castor Oil” from Sigma-Aldrich;
Additive Y2: Macrogol-40 glycerol hydroxystearate, ethoxylated, hydrogenated castor oil, available under the name “Emulgin C₀₄₀” from BASF SE, D-Ludwigshafen;
Additive Y3: Silicone oil, available under the name “AK 1000” from Wacker Chemie AG, D-Munich;
Additive Y4: Lubricant compound 1, available under the name “Struktol TPW 113” from Schill and Seilacher Struktol, D-Hamburg;
Additive Y5: Lubricant compound 2, available under the name “Struktol TPW 104” from Schill and Seilacher Struktol, D-Hamburg;
Fibers B1: Wood fibers (commercially available under the name Lignocell C₃₂₀ from JRS Rettenmaier & Sons GmbH and Co. KG, D-Rosenberg);
Polymer C1: Maleic anhydride-functionalized polyethylene (commercially available under the name “Scona TSPE 2102 GAHD” from BYK Kometra GmbH, D-Schkopau);
Polymer C2: Maleic anhydride-functionalized polypropylene (commercially available under the name “Scona TPPP 8112 FA” from BYK Kometra GmbH, D-Schkopau);

### EXAMPLE 1 (PREPARATION OF MASTERBATCH I)

1.50 kg of silicone 2 were mixed with 8.50 kg of polymer EVA1 and compounded at a temperature of 120° C. in a counter-rotating ZK 25 twin-screw extruder from Collin (D-Ebersberg). The temperature in the feed area (zone 1) was 60° C., which was increased to 100° C. in zone 2 and to 120° C. in zone 3. Zone 4 and Zone 5 were also at 120° C. and the nozzle was temperature-controlled at 110° C. The mixture was extruded as a strand which was then pelletized. The discharge rate was 2.2 kg/h. This gave 9.85 kg of Masterbatch I having a silicone 2 content of 15% by weight and 85% by weight of an EVA having a vinyl acetate content of 19% by weight.

### EXAMPLE 2 (PREPARATION OF MASTERBATCH II)

1.50 kg of silicone 2 were mixed with 8.50 kg of polymer EVA2 and compounded at a temperature of 120° C. in a counter-rotating ZK 25 twin-screw extruder from Collin (D-Ebersberg). The temperature in the feed area (zone 1) was 60° C., which was increased to 100° C. in zone 2 and to 120° C. in zone 3. Zone 4 and Zone 5 were also at 120° C. and the nozzle was temperature-controlled at 110° C. The mixture was extruded as a strand which was then pelletized. The discharge rate was 2.2 kg/h. This gave 9.85 kg of Masterbatch II having a silicone 2 content of 15% by weight and 85% by weight of an EVA having a vinyl acetate content of 28% by weight.

### EXAMPLE 3 (PREPARATION OF MASTERBATCH III)

1.50 kg of silicone 2 and 1.5 kg of additive Y1 were mixed with 7.00 kg of polymer EVA1 and compounded at a temperature of 120° C. in a counter-rotating ZK 25 twin-screw extruder from Collin (D-Ebersberg). The temperature in the feed area (zone 1) was 60° C., which was increased to 100° C. in zone 2 and to 120° C. in zone 3. Zone 4 and Zone 5 were also at 120° C. and the nozzle was temperature-controlled at 110° C. The mixture was extruded as a strand which was then pelletized. The discharge rate was 2.2 kg/h. This gave 9.85 kg of Masterbatch III having a silicone 2 content of 15% by weight and 70% by weight of an EVA having a vinyl acetate content of 19% by weight and 15% by weight of a further external lubricant Y1.

### EXAMPLE 4 (PREPARATION OF MASTERBATCH IV)

1.50 kg of silicone 2 and 1.50 kg of ethoxylated additive Y2 were mixed with 7.00 kg of polymer EVA2 and compounded at a temperature of 120° C. in a counter-rotating ZK 25 twin-screw extruder from Collin (D-Ebersberg). The temperature in the feed area (zone 1) was 60° C., which was increased to 100° C. in zone 2 and to 120° C. in zone 3. Zone 4 and Zone 5 were also at 120° C. and the nozzle was temperature-controlled at 110° C. The mixture was extruded as a strand which was then pelletized. The discharge rate was 2.2 kg/h. This gave 9.87 kg of Masterbatch IV having a silicone 2 content of 15% by weight and 70% by weight of an EVA having a vinyl acetate content of 28% by weight and 15% by weight of a further external lubricant Y2.

### EXAMPLE 5 (PREPARATION OF MASTERBATCH V)

3.00 kg of silicone 2 were mixed with 7.00 kg of polymer EVA2 and compounded at a temperature of 120° C. in a counter-rotating ZK 25 twin-screw extruder from Collin (D-Ebersberg). The temperature in the feed area (zone 1) was 60° C., which was increased to 100° C. in zone 2 and to 120° C. in zone 3. Zone 4 and Zone 5 were also at 120° C. and the nozzle was temperature-controlled at 110° C. The mixture was extruded as a strand which was then pelletized. The discharge rate was 2.2 kg/h. This gave 9.80 kg of Masterbatch V having a silicone 2 content of 30% by weight and 70% by weight of an EVA having a vinyl acetate content of 28% by weight.

### EXAMPLE 6 NON-INVENTIVE (PREPARATION OF MASTERBATCH VI)

3.00 kg of additive Y3 were mixed with 7.00 kg of polymer EVA2 and compounded at a temperature of 120° C. in a counter-rotating ZK 25 twin-screw extruder from Collin (D-Ebersberg). The temperature in the feed area (zone 1) was 60° C., which was increased to 100° C. in zone 2 and to 120° C. in zone 3. Zone 4 and Zone 5 were also at 120° C. and the nozzle was temperature-controlled at 110° C. The mixture was extruded as a strand which was then pelletized. The discharge rate was 1.8 kg/h. This gave 9.65 kg of Masterbatch VI having an additive Y3 content of 30% by weight and 70% by weight of an EVA having a vinyl acetate content of 28% by weight.

### EXAMPLE 7 (PREPARATION OF MASTERBATCH VII)

2.00 kg of silicone 2 and 1.00 kg of additive Y2 were mixed with 7.00 kg of polymer EVA2 and compounded at a temperature of 120° C. in a counter-rotating ZK 25 twin-screw extruder from Collin (D-Ebersberg). The temperature in the feed area (zone 1) was 60° C., which was increased to 100° C. in zone 2 and to 120° C. in zone 3. Zone 4 and Zone 5 were also at 120° C. and the nozzle was temperature-controlled at 110° C. The mixture was extruded as a strand which was then pelletized. The discharge rate was 2.2 kg/h. This gave 9.85 kg of Masterbatch VII having a silicone 2 content of 20% by weight, 10% by weight of additive Y2 and 70% by weight of an EVA having a vinyl acetate content of 28% by weight.

### EXAMPLE 8 (PREPARATION OF MASTERBATCH VIII)

1.00 kg of silicone 2 and 2.00 kg of additive Y2 were mixed with 7.00 kg of polymer EVA2 and compounded at a temperature of 120° C. in a counter-rotating ZK 25 twin-screw extruder from Collin (D-Ebersberg). The temperature in the feed area (zone 1) was 60° C., which was increased to 100° C. in zone 2 and to 120° C. in zone 3. Zone 4 and Zone 5 were also at 120° C. and the nozzle was temperature-controlled at 110° C. The mixture was extruded as a strand which was then pelletized. The discharge rate was 2.2 kg/h. This gave 9.85 kg of Masterbatch VIII having a silicone 2 content of 10% by weight, 20% by weight additive Y2 and 70% by weight of an EVA having a vinyl acetate content of 28% by weight.

### EXAMPLE 9 (PREPARATION OF MASTERBATCH IX)

1.0 kg of silicone 3 and 1.0 kg of additive Y2 were mixed with 4.70 kg of polymer EVA1 and compounded at a temperature of 120° C. in a counter-rotating ZK 25 twin-screw extruder from Collin (D-Ebersberg). The temperature in the feed area (zone 1) was 60° C., which was increased to 100° C. in zone 2 and to 120° C. in zone 3. Zone 4 and Zone 5 were also at 120° C. and the nozzle was temperature-controlled at 110° C. The mixture was extruded as a strand which was then pelletized. The discharge rate was 2.2 kg/h. This gave 6.55 kg of Masterbatch IX having a silicone 3 content of 15% by weight, 15% by weight of additive Y2 and 70% of an EVA having a vinyl acetate content of 19% by weight.

TABLE 1

| | Example | | | | | | | | |
|---|---|---|---|---|---|---|---|---|---|
| | 1 | 2 | 3 | 4 | 5 | 6 | 7 | 8 | 9 |
| | Masterbatch | | | | | | | | |
| | I | II | III | IV | V | VI | VII | VIII | IX |
| EVA 1 [kg] | 8.5 | | 7.0 | | | | | | 4.7 |
| EVA 2 [kg] | | 8.5 | | 7.0 | 7.0 | 7.0 | 7.0 | 7.0 | |
| Silicone 2 [kg] | 1.5 | 1.5 | 1.5 | 1.5 | 3.0 | | 2.0 | 1.0 | |
| Silicone 3 [kg] | | | | | | | | | 1.0 |
| Additive Y1 [kg] | | | 1.5 | | | | | | |
| Additive Y2 [kg] | | | | 1.5 | | | 1.0 | 2.0 | 1.0 |
| Additive Y3 [kg] | | | | | | 3.0 | | | |
| Sum of the individual | 10 | 10 | 10 | 10 | 10 | 10 | 10 | 10 | 6.7 |
| components [kg] | | | | | | | | | |
| Isolated amount of | 9.85 | 9.85 | 9.85 | 9.87 | 9.80 | 9.65 | 9.85 | 9.85 | 6.55 |
| granules [kg] | | | | | | | | | |

It can be seen that by combining appropriate carrier polymers (here EVA), the additives can be obtained either alone or in combination with other additives in relatively high concentrations as masterbatches (Z) in granular form.

### EXAMPLES 10-26

Wood fiber compounds were produced with the components listed in Table 2 in the amounts stated therein (each in kg). The specified components were each independently metered in gravimetrically into a co-rotating ZSK 26 Mc twin-shaft kneader from Coperion (Stuttgart, DE) in zone 1. The temperature of zone 1 was 195° C., the temperature of zone 2 was 190° C., the temperature of zone 3 was 190° C., the temperature of zone 4 was 185° C. and the temperature of zone 5 was also 185° C. The nozzle temperature was 190° C. The polymer melt obtained was pelletized directly after nozzle discharge using an underwater pelletizing system from Econ (Weisskirchen/Traun, AT) at a cooling water temperature of 18° C. The discharge rate of the polymer mixture was 15 kg/h.

Example 26 is a non-inventive comparative example to illustrate the production of wood fiber compounds without lubricants.

TABLE 2

| Example | 10 | 11 | 12 | 13 | 14 | 15 | 16 | 17 | 18 |
|---|---|---|---|---|---|---|---|---|---|
| Masterbatch IV | | | 2 | | | | | | |
| Masterbatch V | 0.5 | 0.5 | | | | | | | |
| Masterbatch VI | | 2 | | | | | | | |
| Masterbatch VII | | | | 1.5 | 2.0 | 2.5 | 0.75 | 1.0 | 1.25 |
| Masterbatch VIII | | | | | | | 0.75 | 1.0 | 1.25 |
| Polymer PE1 | 39.5 | 37.5 | 38.0 | 37.5 | 37.0 | 36.5 | 37.5 | 37.0 | 36.5 |
| Fibers B1 | 60 | 60 | 60 | 60 | 60 | 60 | 60 | 60 | 60 |
| Polymer C1 | | | | 1.0 | 1.0 | 1.0 | 1.0 | 1.0 | 1.0 |
| Sum of the individual | 100 | 100 | 100 | 100 | 100 | 100 | 100 | 100 | 100 |
| components | | | | | | | | | |
| Isolated amount of | 87 | 89 | 91 | 93 | 91 | 94 | 92 | 96 | 92 |
| granules [kg] | | | | | | | | | |

TABLE 3

| Example | 19 | 20 | 21 | 22 | 23 | 24 | 25 | 26 |
|---|---|---|---|---|---|---|---|---|
| Masterbatch III | | | | 1.5 | 2.0 | 2.5 | | |
| Masterbatch IV | | | | | | | | |
| Masterbatch V | | | | | | | | |
| Masterbatch VI | | | | | | | | |
| Masterbatch VII | | | | | | | | |
| Masterbatch VIII | 1.5 | 2.0 | 2.5 | | | | | |
| Masterbatch IX | | | | | | | 2.0 | |
| Polymer PE1 | 37.5 | 37.0 | 36.5 | 37.5 | 37.0 | 36.5 | 37.0 | 39 |
| Fibers B1 | 60 | 60 | 60 | 60 | 60 | 60 | 60 | 60 |
| Polymer C1 | 1 | 1 | 1 | 1 | 1 | 1 | 1 | 1 |
| Sum of the individual | 100 | 100 | 100 | 100 | 100 | 100 | 100 | 100 |
| components | | | | | | | | |
| Isolated amount of | 91 | 89 | 93 | 90 | 94 | 93 | 94 | 95 |
| granules [kg] | | | | | | | | |

### EXAMPLES 27-43

The polymer mixtures obtained in Examples 10-26 were gravimetrically metered into zone 1 of a counter-rotating twin-screw extruder (Battenfeld Cincinnati Austria, Fiberex K38) at 20 kg/h. The temperature of zone 1 was 195° C., the temperature of zone 2 was 170° C., the temperature of zone 3 was 180° C., the temperature of zone 4 was 180° C. and the temperature of zone 5 was also 180° C. The nozzle temperature was 190° C. The extruder rotational speed was 20 rpm. The melt temperature was ca. 190° C. in each case. The polymer melt obtained was extruded on exiting the nozzle as a profile having a width of 80 mm and a height of 25 mm, cooled to 32° C. by means of a cooling belt and cut to size.

Example 43 is a non-inventive comparative example.

TABLE 4

| Example | | | | | | | | |
|---|---|---|---|---|---|---|---|---|
| 27 | 28 | 29 | 30 | 31 | 32 | 33 | 34 | 35 |
| Compound of example | | | | | | | | |
| 10 | 11 | 12 | 13 | 14 | 15 | 16 | 17 | 18 |

Extrusion parameters

| | | | | | | | | | |
|---|---|---|---|---|---|---|---|---|---|
| Spec. power [Wh/kg] | 128 | 111 | 112 | 137 | 135 | 135.5 | 137 | 136.5 | 135 |
| (Target < 140 Wh/kg) | | | | | | | | | |
| Extruder load [%] | 36 | 31.5 | 32 | 39.0 | 39.0 | 39.0 | 39.0 | 38.5 | 38.5 |
| Melt temperature in ° C. | 178 | 175 | 177 | 178 | 178 | 178 | 175 | 176 | 175 |
| Melt pressure [MPa] | 77 | 100 | 85 | 86 | 89 | 89 | 89 | 89 | 85 |

Mechanical properties

| | | | | | | | | | |
|---|---|---|---|---|---|---|---|---|---|
| Density [g/cm³] | 1.12 | 1.02 | 1.14 | 1.15 | 1.16 | 1.16 | 1.16 | 1.16 | 1.16 |
| Flexural E-modulus [MPa] | 2862 | 1587 | 1960 | 2992 | 3477 | 3359 | 3535 | 3524 | 3416 |
| Flexural strength [MPa] | 28.32 | 13.91 | 16.88 | 30.45 | 36.65 | 35.85 | 37.75 | 34.11 | 22.93 |
| Impact resistance [N/mm²] | n.d. | 4.17 | 5.21 | n.d. | n.d. | n.d. | n.d. | n.d. | n.d. |
| Water absorption after 7 days' storage | n.d. | | | 8.24 | 6.88 | 7.12 | 6.27 | 7.44 | 7.36 |
| Water absorption after 28 days' | n.d. | 30.74 | 21.49 | | | | | | |
| storage [%](target ≤ 15%) | | | | | | | | | |
| Visual assessment | 4 | 3 | 3 | 2 | 1 | 1 | 1 | 1 | 2 |

TABLE 5

| Example | | | | | | | |
|---|---|---|---|---|---|---|---|
| 36 | 37 | 38 | 39 | 40 | 41 | 42 | 43 |
| Compound of example | | | | | | | |
| 19 | 20 | 21 | 22 | 23 | 24 | 25 | 26 |

Extrusion parameters

| | | | | | | | | |
|---|---|---|---|---|---|---|---|---|
| Spec. power [Wh/kg] | 139.00 | 136.00 | 138.50 | 140.50 | 135.00 | 136.00 | 135.0 | 158.0 |
| (Target < 140 Wh/kg) | | | | | | | | |
| Extruder load [%] | 39.50 | 39.00 | 40.00 | 39.50 | 38.00 | 38.50 | 39.0 | 44.0 |
| Melt temperature in ° C. | 174 | 174.5 | 174.7 | 174.5 | 174.4 | 174.2 | 176.7 | 178.3 |
| Melt pressure [MPa] | 92 | 88.5 | 98 | 88 | 85.5 | 89 | 86 | 102 |

Mechanical properties

| | | | | | | | | |
|---|---|---|---|---|---|---|---|---|
| Density [g/cm3] | 1.15 | 1.15 | 1.15 | 1.15 | 1.15 | 1.15 | 1.16 | 1.15 |
| Flexural E-modulus [MPa] | 3481 | 3148 | 3245 | 3140 | 3210 | 3180 | 3358 | 3653 |
| Flexural strength [MPa] | 34 | 32.53 | 33.21 | 31.29 | 32.80 | 33.10 | 35.80 | 36.2 |
| Impact resistance [N/mm²] | n.d. | n.d. | n.d. | n.d. | n.d. | n.d. | n.d. | n.d. |
| Water absorption after 7 days, | 7.15 | 7.69 | 7.72 | 7.66 | 7.54 | 7.70 | 7.10 | 6.21 |
| storage [%] | | | | | | | | |
| Visual assessment | 2 | 2 | 1 | 2 | 2 | 1 | 1 | 5 |

Without the use of lubricant compounds (e.g. non-inventive Example 43), significantly higher extrusion capacities are required and, above all, the dimensional stability of the extruded profile is poor, mainly because the profile splits at the edges, which leads to a poor visual assessment.

### EXAMPLES 44-52

Wood fiber compounds were produced with the components listed in Table 6 in the amounts stated therein (each in kg). The specified components were each independently metered in gravimetrically into a co-rotating ZSK 26 Mc twin-shaft kneader from Coperion (Stuttgart, DE) in zone 1. The temperature of zone 1 was 195° C., the temperature of zone 2 was 190° C., the temperature of zone 3 was 190° C., the temperature of zone 4 was 185° C. and the temperature of zone 5 was also 185° C. The nozzle temperature was 190° C. The polymer melt obtained was extruded directly after nozzle discharge as a colored profile having a width of 80 mm and a height of 25 mm, cooled to 32° C. by means of a cooling belt and cut to size. The discharge capacity was 20 kg/h. Examples 44-46 are to be regarded as comparative examples and not according to the invention.

TABLE 6

| Example | 44 | 45 | 46 | 47 | 48 | 49 | 50 | 51 | 52 |
|---|---|---|---|---|---|---|---|---|---|
| Masterbatch IV | | | | 1.5 | 2.0 | 1.5 | 2.0 | 1.5 | 2.0 |
| Additive Y4 | | 3.0 | | | | | | | |
| Additive Y5 | | | 4.0 | | | | | | |
| Polymer PE1 | 40 | 35.0 | 34.0 | 36.5 | 36.0 | | | | |
| Polymer PE2 | | | | | | 36.5 | 36.0 | 37.5 | 37.0 |
| Polymer C1 | | 2.0 | 2.0 | 2.0 | 2.0 | 2.0 | 2.0 | 1.0 | 1.0 |
| Fibers B1 | 60 | 60 | 60 | 60 | 60 | 60 | 60 | 60 | 60 |
| Sum of the individual | 100 | 100 | 100 | 100 | 100 | 100 | 100 | 100 | 100 |
| components | | | | | | | | | |

Extrusion parameters

| | | | | | | | | | |
|---|---|---|---|---|---|---|---|---|---|
| Spec. power [Wh/kg] | 146.5 | 131.00 | 137.00 | 135.00 | 135.50 | 137.00 | 136.50 | 135.00 | 139.00 |
| Extruder load [%] | 41.5 | 37.5 | 39.0 | 39.5 | 38.5 | 39.0 | 38.5 | 38.5 | 39.5 |
| Melt temperature in ° C. | 176 | 176 | 178 | 178 | 178 | 176 | 175 | 176 | 174 |

Mechanical properties

| | | | | | | | | | |
|---|---|---|---|---|---|---|---|---|---|
| Density | 1.13 | 1.12 | 1.15 | 1.16 | n.d. | 1.16 | 1.16 | 1.16 | 1.15 |
| Flexural E-modulus | n.d. | 2506 | 2992 | 3477 | n.d. | 3535 | 3524 | 3416 | 3481 |
| [MPa] | | | | | | | | | |
| Flexural strength [MPa] | n.d. | 19.76 | 30.45 | 36.65 | n.d. | 37.75 | 34.11 | 22.93 | 34 |
| Water absorption after | n.d. | 10.98 | 8.24 | 6.88 | n.d. | 6.27 | 7.44 | 7.36 | 7.15 |
| 7 days' storage | | | | | | | | | |
| Optical assessment of | 5 | 2 | 2 | 2 | 1 | 1 | 2 | 2 | 2 |
| the profiles | | | | | | | | | |

The mixtures of Examples 47 to 52 according to the invention are the polymer/natural fiber compounds that combine a strong reduction in power consumption during extrusion while at the same time maintaining low water absorption with very good mechanical properties and exhibit a good to very good profile surface.

### EXAMPLES 53-55

Wood fiber compounds were produced with the components listed in Table 7 in the amounts stated therein (each in kg). The specified components were each independently metered in gravimetrically into a co-rotating ZSK 26 Mc twin-shaft kneader from Coperion (Stuttgart, DE) in zone 1. The temperature of zone 1 was 220° C., the temperature of zone 2 was 190° C., the temperature of zone 3 was 180° C., the temperature of zone 4 was 180° C. and the temperature of zone 5 was also 180° C. The nozzle temperature was 180° C. The polymer melt obtained was extruded directly after nozzle discharge as a colored profile having a width of 80 mm and a height of 25 mm, cooled to 32° C. by means of a cooling belt and cut to size. The discharge capacity was 20 kg/h. Example 53, in which no lubricant additives are used, is to be regarded as a comparative example and not according to the invention.

TABLE 7

| Example | 53 | 54 | 55 |
|---|---|---|---|
| Masterbatch IV | | 1.0 | 1.5 |
| Polymer PP1 | 38 | 37.0 | 36.5 |
| Polymer C2 | 2.0 | 2.0 | 2.0 |
| Fibers B1 | 60 | 60 | 60 |
| Sum of the individual components | 100 | 100 | 100 |

Extrusion parameters

| | | | |
|---|---|---|---|
| Spec. power [Wh/kg] | 153.5 | 135.00 | 136.00 |
| Extruder load [%] | 48 | 42 | 43 |
| Melt temperature in ° C. | 185 | 182 | 180 |

Mechanical properties

| | | | |
|---|---|---|---|
| Flexural E-modulus [MPa] | 4410 | 3451 | 4325 |
| Flexural strength [MPa] | 53.2 | 38.9 | 52.1 |
| Water absorption after 7 days' storage | 2.8 | 3.9 | 3.1 |
| Optical assessment of the profiles | 5 | 2 | 1 |

It can be seen that Masterbatch IV also results in an improvement in the extrusion properties here, while at the same time maintaining good mechanical properties and a very good optical profile quality.

The flexural properties were determined in each case in accordance with EN ISO 178. The test speed was 3 mm/min, the number of samples measured was 6, the sample size was 80 mm×10 mm×4 mm.

The Charpy impact resistance (unnotched) was determined according to EN ISO 179. The impact pendulum had an impact energy of 0.5 J. The number of samples measured was 10. The sample size was 80 mm×10 mm×4 mm.

To determine the water absorption, 2 samples each having a dimension of 50 mm×50 mm×4 mm were stored at a temperature of 20±2° C. and with an immersion time of 7 days or 28 days in deionized water so that they were completely surrounded by the water. Prior to starting the storage in water, the samples were each dried in a drying cabinet at 80° C. for 72 hours. After the aforementioned immersion time, the samples are removed from the water bath and the water on the surface is blotted. The water absorption is calculated by establishing the quotient of the weight increase after storage in water and the original weight prior to storage in water.

The optical assessment of the manufactured profiles is based on a 6-stage system: 1=very good; 2=good; 3=satisfactory; 4=sufficient, 5=insufficient, 6=unsatisfactory.

The waviness of the manufactured profiles and the surface roughness and the edge precision were taken into account in the assessment.

1-12. (canceled)

13. A mixture, comprising:
(A) organosilicon compounds of the general formula (I)
R_{3-a-b}(OR¹)ₐR²_{b}Si[OSiR₂]ₚ[OSiRR²]_{q}[OSiR²₂]ᵣOSiR_{3-a-b}(OR¹)ₐR²_{b} (I),
wherein R may be identical or different and is a monovalent, optionally substituted, SiC-bonded hydrocarbon radical;
wherein R¹ may be identical or different and is a hydrogen atom or a monovalent, optionally substituted hydrocarbon radical;
wherein R² is a SiC-bonded unit of the general formula
R³—X—[CO—(CO)ₙ]—X—R⁴— (II)
wherein X may be identical or different and is —O— or —NR^{x}—;
wherein R³ may be identical or different and are monovalent, optionally substituted hydrocarbon radicals having at least 6 carbon atoms;
wherein R⁴ are divalent, optionally substituted hydrocarbon radicals having 1 to 40 carbon atoms, wherein individual carbon atoms may be replaced by oxygen atoms or —NR^{z}—;
wherein R^{x} may be identical or different and is a hydrogen atom or monovalent, optionally substituted hydrocarbon radicals having 1 to 20 carbon atoms, wherein individual carbon atoms may be replaced by oxygen atoms;
wherein R^{z} may be identical or different and is a hydrogen atom or monovalent, optionally substituted hydrocarbon radicals having 1 to 20 carbon atoms, wherein individual carbon atoms may be replaced by oxygen atoms;
wherein n is 0 or 1;
wherein a is 0, 1, 2 or 3;
wherein b is 0 or 1;
wherein p is an integer from 1 to 1000;
wherein q is 0 or an integer from 1 to 100;
wherein r is 0 or an integer from 1 to 100; and
wherein a+b is ≤3 and at least one R² radical is present;
(B) organic fibers;
(C) thermoplastic polymers; and
optionally (D) polyolefins substituted by carboxylic acid anhydride groups.

14. The mixture of claim 13, wherein the organosilicon compounds of the formula (I) have a number-average molecular weight Mn of 1000 g/mol to 35 000 g/mol.

15. The mixture of claim 13, wherein the proportion of the organosilicon compounds (A) in the mixture is between 100 ppm by weight and 20 000 ppm by weight.

16. The mixture of claim 13, wherein the component (C) is high-density polyethylene (HDPE), polypropylene, ethylene-vinyl acetate copolymers (EVA) or mixtures thereof.

17. The mixture of claim 13, wherein the component (B) is wood.

18. The mixture of claim 13, wherein the proportion of organic fibers (B) in the mixture is between 30 and 90% by weight.

19. The mixture of claim 13, further comprising:
(E) flame retardants, (F) biocides, (G) pigments, (H) UV absorbers, (I) HALS stabilizers, (J) inorganic fibers, (K) lubricants and/or adhesion promoters (L).

20. The mixture of claim 13, wherein the mixture is an extrudable molding

21. A process for producing mixtures, comprising:
providing a component (A) of organosilicon compounds of the general formula (I)
R_{3-a-b}(OR¹)ₐR²_{b}Si[OSiR₂]ₚ[OSiRR²]_{q}[OSiR²₂]ᵣOSiR_{3-a-b}(OR¹)ₐR²_{b} (I),
wherein R may be identical or different and is a monovalent, optionally substituted, SiC-bonded hydrocarbon radical;
wherein R¹ may be identical or different and is a hydrogen atom or a monovalent, optionally substituted hydrocarbon radical;
wherein R² is a SiC-bonded unit of the general formula
R³—X—[CO—(CO)ₙ]—X—R⁴— (II)
wherein X may be identical or different and is —O— or —NR^{x}—;
wherein R³ may be identical or different and are monovalent, optionally substituted hydrocarbon radicals having at least 6 carbon atoms;
wherein R⁴ are divalent, optionally substituted hydrocarbon radicals having 1 to 40 carbon atoms, wherein individual carbon atoms may be replaced by oxygen atoms or —NR^{z}—;
wherein R^{x} may be identical or different and is a hydrogen atom or monovalent, optionally substituted hydrocarbon radicals having 1 to 20 carbon atoms, wherein individual carbon atoms may be replaced by oxygen atoms;
wherein R^{z} may be identical or different and is a hydrogen atom or monovalent, optionally substituted hydrocarbon radicals having 1 to 20 carbon atoms, wherein individual carbon atoms may be replaced by oxygen atoms;
wherein n is 0 or 1;
wherein a is 0, 1, 2 or 3;
wherein b is 0 or 1;
wherein p is an integer from 1 to 1000;
wherein q is 0 or an integer from 1 to 100;
wherein r is 0 or an integer from 1 to 100; and
wherein a+b is ≤3 and at least one R² radical is present;
providing a component (B) of organic fibers;
providing a component (C) of thermoplastic polymers;
optionally providing a component (D) of polyolefins substituted by carboxylic acid anhydride groups; and
mixing the individual components in any sequence.

22. The process of claim 21, wherein the composition is an extrudable molding

23. A composition (Z), comprising:
(A) at least one organosilicon compound of the general formula (I),
R_{3-a-b}(OR¹)ₐR²_{b}Si[OSiR₂]ₚ[OSiRR²]_{q}[OSiR²₂]ᵣOSiR_{3-a-b}(OR¹)ₐR²_{b} (I),
wherein R may be identical or different and is a monovalent, optionally substituted, SiC-bonded hydrocarbon radical;
wherein R¹ may be identical or different and is a hydrogen atom or a monovalent, optionally substituted hydrocarbon radical;
wherein R² is a SiC-bonded unit of the general formula
R³—X—[CO—(CO)ₙ]—X—R⁴— (II)
wherein X may be identical or different and is —O— or —NR^{x}—;
wherein R³ may be identical or different and are monovalent, optionally substituted hydrocarbon radicals having at least 6 carbon atoms;
wherein R⁴ are divalent, optionally substituted hydrocarbon radicals having 1 to 40 carbon atoms, wherein individual carbon atoms may be replaced by oxygen atoms or —NR^{z}—;
wherein R^{x} may be identical or different and is a hydrogen atom or monovalent, optionally substituted hydrocarbon radicals having 1 to 20 carbon atoms, wherein individual carbon atoms may be replaced by oxygen atoms;
wherein R^{z} may be identical or different and is a hydrogen atom or monovalent, optionally substituted hydrocarbon radicals having 1 to 20 carbon atoms, wherein individual carbon atoms may be replaced by oxygen atoms;
wherein n is 0 or 1;
wherein a is 0, 1, 2 or 3;
wherein b is 0 or 1;
wherein p is an integer from 1 to 1000;
wherein q is 0 or an integer from 1 to 100;
wherein r is 0 or an integer from 1 to 100; and
wherein a+b is ≤3 and at least one R² radical is present;
(C1) thermoplastic polymers selected from the group consisting of ethylene-vinyl acetate copolymers and ethylene-alkyl acrylate copolymers; and
optionally (Y) additives.

24. The composition (Z) of claim 23, wherein the composition (Z) is an extrudable molding

25. A process for producing compositions (Z), comprising:
providing a component (A) of at least one organosilicon compound of the general formula (I),
R_{3-a-b}(OR¹)ₐR²_{b}Si[OSiR₂]ₚ[OSiRR²]_{q}[OSiR²₂]ᵣOSiR_{3-a-b}(OR¹)ₐR²_{b} (I),
wherein R may be identical or different and is a monovalent, optionally substituted, SiC-bonded hydrocarbon radical;
wherein R¹ may be identical or different and is a hydrogen atom or a monovalent, optionally substituted hydrocarbon radical;
wherein R² is a SiC-bonded unit of the general formula
R³—X—[CO—(CO)ₙ]—X—R⁴— (II)
wherein X may be identical or different and is —O— or —NR^{x}—;
wherein R³ may be identical or different and are monovalent, optionally substituted hydrocarbon radicals having at least 6 carbon atoms;
wherein R⁴ are divalent, optionally substituted hydrocarbon radicals having 1 to 40 carbon atoms, wherein individual carbon atoms may be replaced by oxygen atoms or —NR^{z}—;
wherein R^{x} may be identical or different and is a hydrogen atom or monovalent, optionally substituted hydrocarbon radicals having 1 to 20 carbon atoms, wherein individual carbon atoms may be replaced by oxygen atoms;
wherein R^{z} may be identical or different and is a hydrogen atom or monovalent, optionally substituted hydrocarbon radicals having 1 to 20 carbon atoms, wherein individual carbon atoms may be replaced by oxygen atoms;
wherein n is 0 or 1;
wherein a is 0, 1, 2 or 3;
wherein b is 0 or 1;
wherein p is an integer from 1 to 1000;
wherein q is 0 or an integer from 1 to 100;
wherein r is 0 or an integer from 1 to 100; and
wherein a+b is ≤3 and at least one R² radical is present;
providing a component (C1) of thermoplastic polymers selected from the group consisting of ethylene-vinyl acetate copolymers and ethylene-alkyl acrylate copolymers;
optionally providing a component (Y) of additives; and
mixing the individual components in any desired sequence.

26. The process of claim 25, wherein the composition (Z) is mixed with a component (B), a component (C) and optionally one or more of components (D) to (L);
wherein (D) is polyolefins substituted by carboxylic acid anhydride groups;
wherein (E) flame retardants;
wherein (F) biocides;
wherein (G) pigments;
wherein (H) UV absorbers;
wherein (I) HALS stabilizers;
wherein (J) inorganic fibers;
wherein (K) lubricants; and
wherein (L) adhesion promoters.

27. The process of claim 25, wherein the compositions (Z) produced are an extrudable molding.
